(19) United States
(12) Patent Application Publication
(10) Pub. No.: US 2003/0014185 A1
(43) Pub. Date: Jan. 16, 2003

(54) Geographic information system and method for providing geographic information

(75) Inventor: Sun-Woo Kim, Gyeonggi-do (KR)

Correspondence Address: SUGHRUE, MION, ZINN, MACPEAK & SEAS, PLLC, 2100 Pennsylvania Avenue, N.W., Washington, DC, 20037-3213, US

(73) Assignee: SAMSUNG ELECTRONICS CO., LTD.

(21) Appl. No.: 10/086,424

(22) Filed: Mar. 4, 2002

(30) Foreign Application Priority Data
Jul. 11, 2001 (KR) 2001-41555

(51) Int. Cl. G01C 21/26

(52) U.S. Cl. 701/202; 701/208; 340/995

(57) ABSTRACT

A geographical information system, which provides each of a plurality of terminal apparatuses having a variety of display attributes with map information having an appropriate resolution, using a database having map information with a single resolution, and a method for providing geographical information appropriate for the system are provided. The geographical information system, which provides map information in response to a request for a map providing service from a plurality of terminal apparatuses having a plurality of different display attributes, has a server having a database of map information with a single resolution, and an information control means which is located between the server and the terminal apparatuses, obtains location information and display description information of the terminal apparatuses from the terminal apparatuses, obtains map information corresponding to map information from the server, and converts the map information and then transmits the map information to the terminal apparatuses.

### BACKGROUND OF THE INVENTION

1. Field of the Invention

The present invention relates to a geographical information system, and more particularly, to a geographical information system which provides each of a plurality of terminal apparatuses having a variety of different display attributes, with map information having an appropriate resolution, using a database having map information with a single resolution, and a method for providing geographical information appropriate for the system. The present application is based on Korean Patent Application No. 2001-41555 filed on Jul. 11, 2001, which is incorporated herein by reference.

2. Description of the Related Art

A geographical information system combines location information and description information on a variety of spatiotemporal phenomena occurring on the earth, appropriately processes and analyzes the combined information, and provides desired geographical information to a user.

Geographical information systems use an electronic map, which is formed with spatial data connecting predetermined points on the earth's surface, which are defined in coordinates of latitude and longitude and description data expressing detailed information related to the spatial data.

The methods for constructing geographical information systems can be classified into two types: a vector type and a raster type. In the vector-type geographical information system, spatial data and description data are produced by forming an independent layer for each desired section in a multilayered structure from the earth's surface to the underground so that 3-dimensional analysis is enabled. In the raster-type geographical information system, all information to be displayed on the earth's surface is divided into cell units forming a mesh. By writing all attributes of a predetermined point into a corresponding cell, spatial data and description data are managed together as unified data.

The vector-type geographical information system is difficult to implement, but enables multilayered analysis. Meanwhile, the raster-type geographical information system is easy to implement, but is not appropriate for multilayered analysis.

As the main goal of using the geographical information system is to analyze a 3-dimensional shape of a multilayered structure, the vector-type geographical information system is mainly used.

Geographical information systems are used with other systems such as an urban information system (UIS), a land information system (LIS), and an environment information system (EIS). In particular, a geographical information system coupled with a global positioning system is widely used in car navigation systems and nautical navigation systems.

Implementation of the geographical information system requires hardware such as a workstation, a personal computer (PC), and networking apparatuses, and software such as a tool for inputting and manipulating geographical information, a database management system, a tool for supporting queries, analysis, and visualization, and a graphical-user interface.

Meanwhile, a variety of information systems on the ground are implemented in a PC or server environment. However, for a mobile body such as a car, the information system is implemented mainly as a small lightweight dedicated terminal apparatus.

In a prior art geographical information system such as a navigation apparatus, when a map is displayed using map information stored in the apparatus, inconsistency in the map may occur depending on the time the map information was stored. Therefore, the user of the navigation apparatus should update map information at an appropriate time. To do this, the navigation apparatus needs a large capacity storage device for storing all the map information. However, it is practically impossible to embed a storage device for storing a large volume of map information in a terminal apparatus of a mobile body, such as a car. In particular, an increase in memory capacity causes an increase in the price of a terminal apparatus.

To solve this problem, a web-based geographical information system using the Internet has been introduced. The web-based geographical information system has a database for storing all the map information and allows a user to download map information of only a predetermined region through the Internet. With the web-based geographical information system, the user downloads map information of only a desired region, which reduces the required memory capacity of a terminal apparatus.

In prior art geographical information systems, however, each terminal apparatus may have different display attributes, for example, different numbers of pixels and colors. Consequently, a plurality of databases, each having map information suitable for a corresponding terminal apparatus, need to be established.

For example, in prior art geographical information systems, a database for storing map information with a resolution of 640×480 pixels and 256 or more colors, which is suitable for a PC, and a separate database for storing map information with a resolution of 160×160 pixels and approximately 16 shades of gray, which is suitable for a personal digital assistant (PDA), are separately established. This increases the cost for establishing a geographical information system.

### SUMMARY OF THE INVENTION

It is a first objective of the present invention to provide an improved geographical information system, which has a database having map information with a single resolution and provides each of a plurality of terminal apparatuses having a plurality of different display attributes with appropriate map information.

It is a second objective of the present invention to provide a method for providing geographical information, in which a geographical information system (GIS) server having a database that has map information with a single resolution provides each of a plurality of terminal apparatuses having a variety of resolutions with map information appropriate for their display attributes.

To accomplish the first objective of the present invention, there is provided a geographical information system which provides map information in response to a request for a map providing service from a plurality of terminal apparatuses having a plurality of different display attributes, the geographical information system having a server having a database of map information with a single resolution; and an information control means which is located between the server and the terminal apparatuses, that obtains location information and display description information of the terminal apparatuses from the terminal apparatuses, obtains map information corresponding to map information from the server, and converts the map information based on display description information of the terminal apparatuses, and then transmits the map information to the terminal apparatuses.

To accomplish the second objective of the present invention, there is provided a geographical information providing method for providing map information using a database having map information with a single resolution, in response to a map providing service request from a plurality of terminal apparatuses having a plurality of different display attributes, the geographical information providing method having the steps of obtaining location information and display description information from the terminal apparatuses; obtaining map information corresponding to location information from the database; converting the map information based on the display attributes of the terminal apparatuses; and providing the converted map information to the terminal apparatuses.

### BRIEF DESCRIPTION OF THE DRAWINGS

The above objects and advantages of the present invention will become more apparent by describing in detail preferred embodiments thereof with reference to the attached drawings in which:

FIG. 1 is a block diagram of the structure of a prior art web-based geographical information system;

FIG. 2 is a block diagram of a preferred embodiment of a geographical information system according to the present invention, which is applied to the world wide web; and

FIG. 3 illustrates a method for providing geographical information according to the present invention, in which a process of connection and capability negotiation between an information control server and terminal apparatuses is shown.

FIG. 4 illustrates a process of transmitting map information, using the geographical information system of FIG. 2, from the web-based GIS server to the terminal apparatus, through the information control server.

### DESCRIPTION OF THE PREFERRED EMBODIMENTS

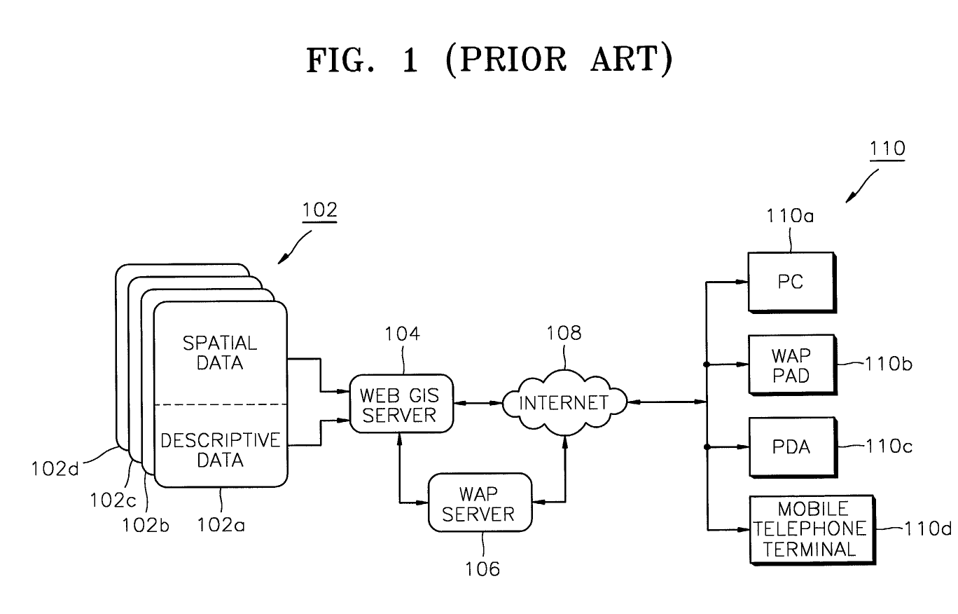

A prior art web-based geographical information system of FIG. 1 includes a database 102, a web-based geographical information system (GIS) server 104, and a wireless application protocol (WAP) server 106.

In the web-based geographical information system of FIG. 1, the database 102 is formed with a set of smaller databases 102a through 102d. The databases 102a through 102d have appropriate map information and respectively correspond to each of a variety of terminal apparatuses, including a PC 110a, a Web PAD (Personal Access Device) 110b, a PDA 110c, and a mobile telephone terminal 110d. Each of databases 102a through 102d has spatial data and description data.

A service request from a terminal apparatus 110 which needs a map providing service is transmitted to the web-based GIS server 104 through the Internet 108. The terminal apparatuses, including the PC 110a, the Web PAD 110b, and the PDA 110c, which can directly process a web page complying with a hypertext transfer protocol (HTTP), establish direct connections to the web-based GIS server 104. A terminal apparatus such as the mobile telephone terminal 110d, which cannot directly process a web page complying with the HTTP protocol, establishes a connection to the web-based GIS server 104 through the WAP server 106. By converting a web page into wireless data or wireless data into a web page, the WAP server 106 enables communications between the web-based GIS server 104 and the mobile telephone terminal 110d.

The web-based GIS server 104 extracts map information based on the location information included in the service request from one of the terminal apparatuses 110, and provides the map information to the terminal apparatus 110. At this time, the web-based GIS server 104 searches for map information corresponding to the terminal apparatus 110 in one of the databases 102 having map information with a resolution corresponding to the terminal apparatus 110 that requested map information.

The prior art web-based geographical information system of FIG. 1 has a database corresponding to each kind of terminal apparatus 110, and therefore there are increased costs.

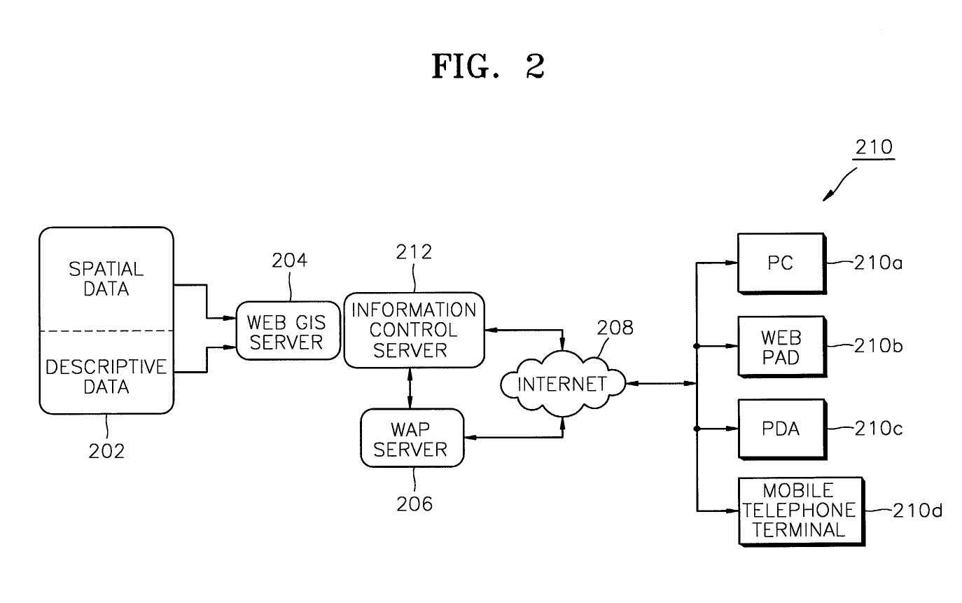

FIG. 2 is a block diagram of a preferred embodiment of a geographical information system according to the present invention, which is applied to the world wide web. The web-based geographical information system of FIG. 2 includes a database 202, a web-based GIS server 204, a WAP server 206, and an information control server 212.

The database 202 has map information with a single resolution, for example, a resolution of 640×480 pixels and 24-bit color which is appropriate for a PC. It is preferable that the resolution of map information in the database 202 is appropriate for a terminal apparatus which uses the highest resolution that can be supported by a geographical information system.

If the geographical information system is a vector type, the database 202 has spatial data and description data.

A terminal apparatus 210 that needs a map providing service, accesses the information control server 212 through the Internet 208, performs user authentication, and requests access to the GIS server 204. The information control server 212 requests location information and display description data from the authenticated terminal apparatus 210. The terminal apparatus 210 provides location information and display description information, for example, the number of pixels and the number of available colors, to the information control server 212.

Meanwhile, the information control server 212, which obtained location information and display description information of the terminal apparatus 210, requests map information corresponding to the location information from the GIS server 204. If map information from the GIS server 204 is received, the information control server 212 makes the number of pixels (or the screen size) and colors of the map information suitable for the display attributes of the terminal apparatus 210, and transmits the map information to the terminal apparatus 210.

In this way, the geographical information system according to the present invention provides the terminal apparatus 210 with map information which is provided by the GIS server 204 and converted to be suitable for the display attributes of the terminal apparatus 210. By doing so, with a database of map information having a single resolution, a service provider can provide map providing services to users of a variety of terminal apparatuses. That is, the service provider can provide web-based services to users of desktop PCs/notebook PCs and can also provide map providing services to users of terminal apparatuses with smaller display devices, such as a PDA or Web PAD.

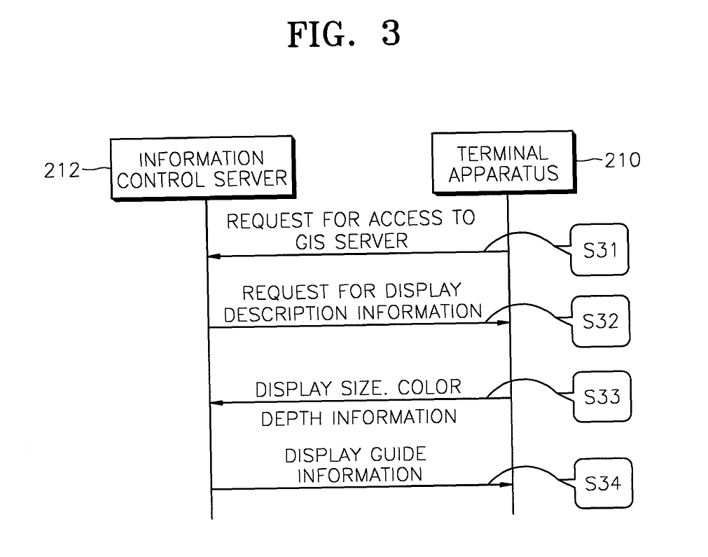

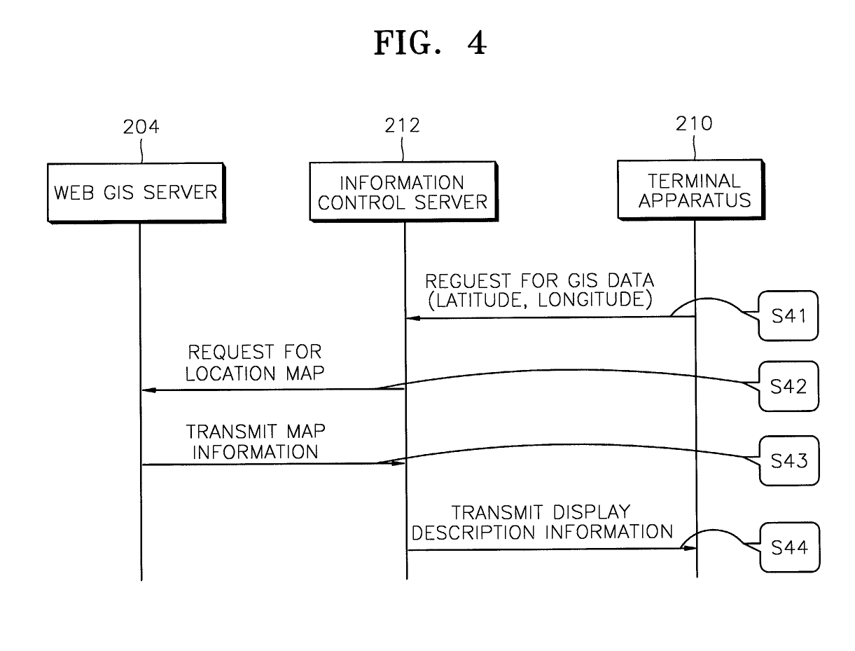

FIGS. 3 and 4 illustrate a method for providing geographical information according to the present invention. FIG. 3 shows a process of connection and capability negotiation between the information control server 212 and terminal apparatuses 210 of FIG. 2.

First, a terminal apparatus 210 sends a request to the information control server 212 for access to the web-based GIS server 204 in step S31. After the authentication procedure for access ends, the information control server 212 requests that the terminal apparatus 210 transmit display description information in step S32.

In response to this request, the terminal apparatus 210 transmits its display attributes, that is, the number of pixels (or the screen size) and the number of available colors in step S33. Then, the information control server 212 transmits display guide information to the terminal apparatus 210 in step S34.

FIG. 4 illustrates a process of transmitting map information, using the geographical information system of FIG. 2, from the web-based GIS server 204 to the terminal apparatus 210 through the information control server 212.

First, in response to a request from the information control server 212, the terminal apparatus 210 provides location information (latitude and longitude) in step S41. After receiving the location information from the terminal apparatus 210, the information control server 212 requests map information corresponding to the location information from the web-based GIS server 204 in step S42.

The web-based GIS server 204 fetches map information corresponding to the location information from the database 202, and provides the map information to the information control server 212 in step S43.

The information control server 212 converts the map information provided by the web-based GIS server 204 to have a resolution suitable for the display attributes of the terminal apparatus 210 and transmits the map information to the terminal apparatus 210.

By converting a web page into wireless data or wireless data into a web page, the WAP server 206 enables communications between the web-based GIS server 204 and the mobile telephone terminal 210d.

Though the web-based geographical information system has been explained as an embodiment of the present invention, the present invention can be applied to all types of geographical information systems. Also, it can be applied to raster-type systems as well as the vector-type systems.

As described above, the geographical information system according to the present invention does not need a plurality of databases each having different resolutions, respectively corresponding to each of a plurality of terminal apparatuses having different resolutions. Therefore, the geographical information system according to the present invention reduces the cost for establishing a geographical information system.

What is claimed is:

1. A geographical information system which provides map information in response to a request for a map providing service from at least one terminal apparatus having a display attribute, the geographical information system comprising:
a server having a database of map information with a single resolution; and
an information control means located between the server and said at least one terminal apparatus, that obtains location information and display description information of said at least one terminal apparatus from said at least one terminal apparatus, obtains map information from the server, and converts the obtained map information based on the display description information of said at least one terminal apparatus, and then transmits the converted map information to said at least one terminal apparatus.

2. The geographical information system of claim 1, wherein the database stores map data appropriate for a terminal apparatus having the highest resolution that is supported by the geographical information system.

3. The geographical information system of claim 1, wherein the display description information includes a number of pixels and a number of colors that are supported by said at least one terminal apparatus.

4. A geographical information providing method for providing map information using a database having map information with a single resolution, in response to a request for a map providing service from at least one terminal apparatus having a display attribute, the geographical information providing method comprising the steps of:
obtaining location information and display description information from said at least one terminal apparatus;
obtaining map information corresponding to the location information from the database;
converting the map information based on the display attribute of said at least one terminal apparatus; and
providing the converted map information to said at least one terminal apparatus.

5. The geographical information providing method of claim 4, wherein the display description information includes a number of pixels and a number of colors that are supported by said at least one terminal apparatus.
